(19) United States
(12) Patent Application Publication
(10) Pub. No.: US 2026/0180852 A1
(43) Pub. Date: Jun. 25, 2026

(54) ARTIFICIAL INTELLIGENCE/MACHINE LEARNING CONFIGURATION AND OPERATION MANAGEMENT DURING RADIO RESOURCE CONTROL STATE CHANGE

(71) Applicant: InterDigital Patent Holdings, Inc., Wilmington, DE (US)

(72) Inventors: Dylan Watts, Montreal (CA); Oumer Teyeb, Montreal (CA); Patrick Tooher, Montreal (CA); Yugeswar Deenoo Narayanan Thangaraj, Chalfont, PA (US); Moon IL Lee, Melville, NY (US); Brian Martin, Farnham (GB); Virgil Comsa, Montreal (CA)

(73) Assignee: InterDigital Patent Holdings, Inc., Wilmington, DE (US)

(21) Appl. No.: 18/990,557

(22) Filed: Dec. 20, 2024

(51) Int. Cl. H04L 41/0803; H04W 24/08; H04W 76/27

(52) U.S. Cl. CPC H04L 41/0803; H04W 24/08; H04W 76/27

(57) ABSTRACT

A method may be performed by a wireless transmit/receive unit (WTRU), including receiving a configuration message. The configuration message may include an indication to suspend an artificial intelligence/machine learning (AI/ML) configuration related to an AI/ML operation, conditions to maintain a suspended AI/ML configuration, and conditions to restore the suspended AI/ML configuration upon transition to a first state. The AI/ML configuration may be suspended when the WTRU is in a second state. The suspended AI/ML configuration may be maintained when in the second state. It may be determined that the suspended AI/ML configuration can be restored upon transition back to the first state based on the one or more conditions. An indication may be sent to the network that indicates that the suspended AI/ML configuration can be restored. An indication that the WTRU should resume the AI/ML operation according to the restored AI/ML configuration may be received.

### BACKGROUND

The 3rd Generation Partnership Project 3GPP has recently begun integration of AI/ML into 5G NR to enhance air-interface performance (e.g., improved throughput, robustness, accuracy, and/or reliability, and/or to reduce complexity and/or overhead). Selection of features may be based on an assessment of their performance in comparison with traditional methods and/or the associated potential specification impact, including, for example AIML for beam management, positioning, and/or CSI prediction. Consideration of multiple features enables a common AI/ML management framework, which may include one or more of the following aspects. Aspects may include signaling and/or protocol aspects of Life Cycle Management (LCM); necessary signaling and/or mechanisms for LCM to facilitate model training, inference, performance monitoring, and/or data collection for both WTRU-sided and network (NW)-sided models; and/or signaling mechanisms of applicable functionalities and/or models.

The current Artificial Intelligence/Machine Learning (AI/ML) framework considers functionality-based LCM. A functionality refers to an AI/ML feature which may be enabled by configurations, and a NW may indicate activation, deactivation, fallback, and/or switching of AI/ML functionality via 3GPP signaling (e.g., Radio Resource Control (RRC), Medium Access Control-Control Element (MAC-CE), and/or Downlink Control Information (DCI)). To support the configuration, activation, and/or deactivation of a functionality, the WTRU may report whether a functionality is applicable based on WTRU and/or NW-side additional conditions (e.g., conditions associated with the NW, such as WTRU speed, and/or a number of antennas), and/or model availability at the WTRU. A WTRU may first be provided an AI/ML configuration, and may report whether the functionality is applicable based on the configuration, or the WTRU may report one or more applicable functionalities and may subsequently receive an AI/ML configuration.

### SUMMARY

A wireless transmit/receive unit (WTRU) may include a processor. The processor may be configured to receive a configuration message. The configuration message may include an indication to suspend an artificial intelligence/machine learning (AI/ML) configuration related to an AI/ML operation, one or more conditions to maintain a suspended AI/ML configuration, and one or more conditions to restore the suspended AI/ML configuration upon transition to a first state. The AI/ML configuration may be suspended when the WTRU is in a second state. The suspended AI/ML configuration may be determined to maintain when in the second state based on one or more conditions. The processor may be configured to determine that the suspended AI/ML configuration can be restored upon transition back to the first state based on the one or more conditions to restore the suspended AI/ML configuration. An indication may be sent to the network that indicates that the suspended AI/ML configuration can be restored. An indication that the WTRU should resume the AI/ML operation according to the restored AI/ML configuration may be received.

The one or more conditions to maintain the suspended AI/ML configuration may include an expiration of a timer, a comparison of a measurement to a threshold, a status of a buffer of the WTRU, or an RRC state of the WTRU.

The processor may be configured to release the suspended AI/ML configuration if the one or more conditions are not met.

The one or more conditions to restore the suspended AI/ML configuration may include a measurement being above a threshold, a condition associated with the network, or that the WTRU transitions back to the first state in the same cell as sent the configuration message to the WTRU.

The processor may be configured to send the indication that indicates that the suspended AI/ML configuration has been restored via a Random Access Channel (RACH) transmission or a WTRU capability message.

The processor may be configured to receive an updated configuration, and to apply the updated configuration to the restored AI/ML configuration.

The processor may be configured to restore the suspended AI/ML configuration based on the indication that the WTRU should resume the AI/ML operation according to the restored AI/ML configuration.

The processor may be configured to perform one or more actions associated with the AI/ML operation after the suspended AI/ML configuration is restored, wherein the one or more actions comprise at least one of performance monitoring, inference, or data collection.

The configuration message may be received via a first cell, the indication that indicates that the suspended AI/ML configuration has been restored may be sent via a second cell, and the indication that the WTRU should resume the AI/ML operation according to the restored AI/ML configuration may be received via the second cell, wherein the second cell may be different from the first cell.

The first state may be a Radio Resource Control (RRC) Connected state, and the second state may be an RRC INACTIVE state.

A method may be performed by a wireless transmit/receive unit (WTRU), including receiving a configuration message. The configuration message may include an indication to suspend an artificial intelligence/machine learning (AI/ML) configuration related to an AI/ML operation, one or more conditions to maintain a suspended AI/ML configuration, and one or more conditions to restore the suspended AI/ML configuration upon transition to a first state. The AI/ML configuration may be suspended when the WTRU is in a second state. The suspended AI/ML configuration may be determined to maintain when in the second state based on one or more conditions. The method may include determining that the suspended AI/ML configuration can be restored upon transition back to the first state based on the one or more conditions to restore the suspended AI/ML configuration. An indication may be sent to the network that indicates that the suspended AI/ML configuration can be restored. An indication that the WTRU should resume the AI/ML operation according to the restored AI/ML configuration may be received.

The one or more conditions to maintain the suspended AI/ML configuration may include an expiration of a timer, a comparison of a measurement to a threshold, a status of a buffer of the WTRU, or a Radio Resource Control (RRC) state of the WTRU.

The method may include releasing the suspended AI/ML configuration if the one or more conditions are not met.

The one or more conditions to restore the suspended AI/ML configuration may include a measurement being above a threshold, a condition associated with the network, or that the WTRU transitions back to the first state in the same cell as sent the configuration message to the WTRU.

The method may include sending the indication that indicates that the suspended AI/ML configuration has been restored via a Random Access Channel (RACH) transmission or a WTRU capability message.

The method may include receiving an updated configuration, and applying the updated configuration to the restored AI/ML configuration.

The method may include restoring the suspended AI/ML configuration based on the indication that the WTRU should resume the AI/ML operation according to the restored AI/ML configuration.

The method may include performing one or more actions associated with the AI/ML operation after the suspended AI/ML configuration is restored, wherein the one or more actions comprise at least one of performance monitoring, inference, or data collection.

The configuration message may be received via a first cell, the indication that indicates that the suspended AI/ML configuration has been restored may be sent via a second cell, and the indication that the WTRU should resume the AI/ML operation according to the restored AI/ML configuration may be received via the second cell, wherein the second cell may be different from the first cell.

The first state may be a Radio Resource Control (RRC) Connected state, and the second state may be an RRC INACTIVE state.

Artificial Intelligence/Machine Learning (AI/ML)-related configuration and operation management upon release from RRC Connected may include AI/ML-related configuration and operation management during the RRC state change and within RRC IDLE and INACTIVE states. The AI/ML-related configuration and operation management may include providing indications on how to manage AI/ML-related configurations and operations, such as upon release from the RRC Connected state. Management may also involve the conditional, time-based, or NW-controlled maintenance of AI/ML-related configurations while the WTRU operates in RRC IDLE or INACTIVE states. The release and/or suspension of AI/ML-related configurations and/or operations may occur, for example, upon expiry of certain conditions and/or when requested by the NW.

Upon returning to the RRC Connected state, AI/ML-related configuration and operation management may focus on the management, availability, and resumption of configurations and operations. This may involve the conditional AI/ML-related configurations upon return to RRC Connected, including, conditional resumption of AI/ML-related configurations and/or operation. An indication of the availability of AI/ML-related configurations may be provided, and AI/ML-related configurations may be modified. Management may include restoring AI/ML configurations and/or resuming AI/ML-related operations.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow diagram illustrating an example method for Artificial Intelligence/Machine Learning (AI/ML) configuration and operation management during a Radio Resource Control (RRC) state change.

### DETAILED DESCRIPTION

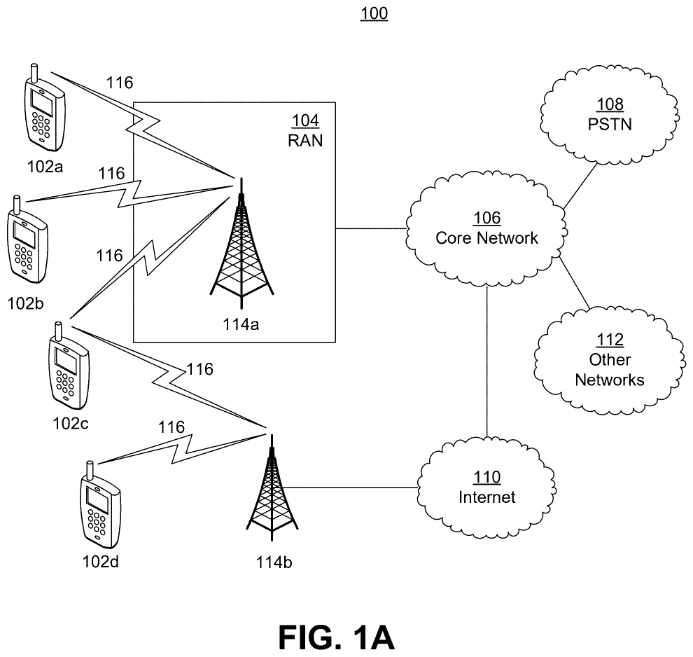

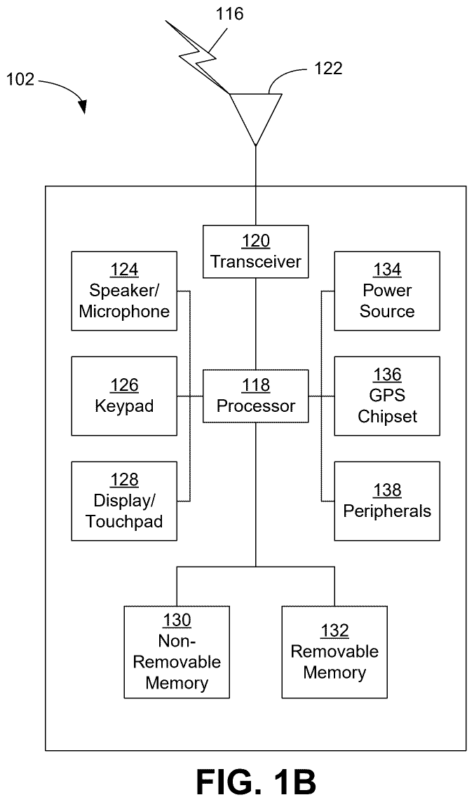

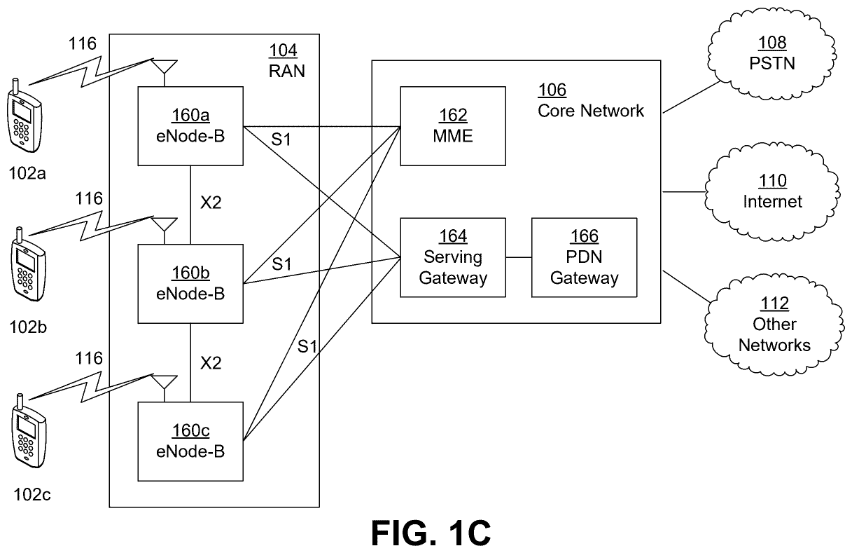

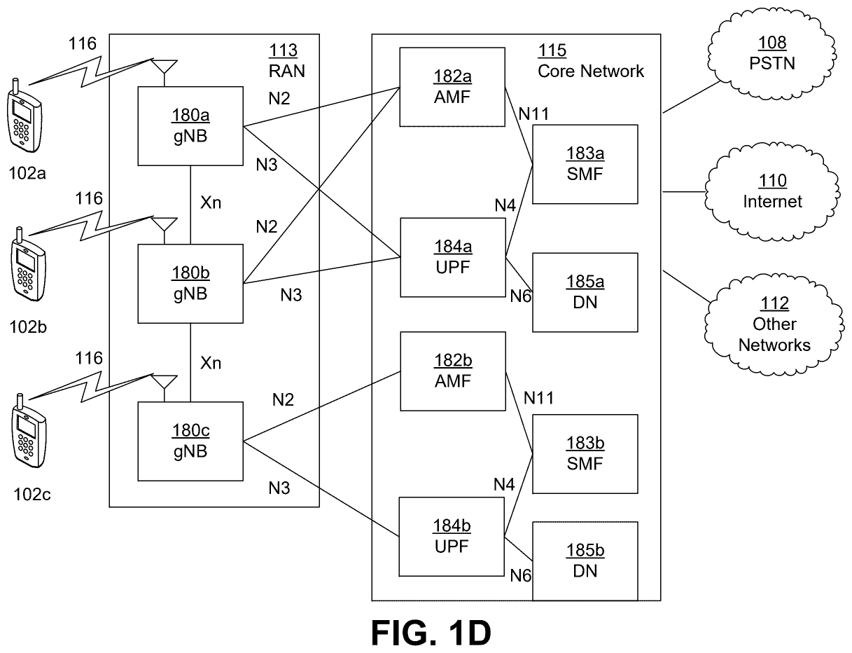

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

AI/ML operation and associated configurations may currently be supported only during RRC Connected, and a wireless transmit/receive unit (WTRU) may report functionality applicability, receive an associated configuration, and/or perform AI/ML operation only upon completion of the RRC Connection's establishment, resume, and/or re-establishment procedures. Upon release from RRC connected state, the WTRU may discontinue AI/ML operation and may release associated AI/ML configurations. However, a WTRU may only temporarily exit the RRC Connected state, for example, to save power consumption during brief periods of data inactivity. Continuously releasing and/or re-acquiring AI/ML configurations in such cases is inefficient, and may cause unnecessary signaling overhead, and/or interruptions to AI/ML operation.

Utilizing current techniques, AI/ML configurations may be provided only within the RRC Connected state. Upon transition to RRC INACTIVE (e.g., upon reception of an RRC Release with suspend indication) and/or RRC IDLE (e.g., upon reception of an RRC Release indication), a WTRU may release all AI/ML related configurations and may terminate all AI/ML related inference operations. Upon RRC connection resume and/or establishment, the WTRU may re-acquire AI/ML related configurations and may restart AI/ML operations.

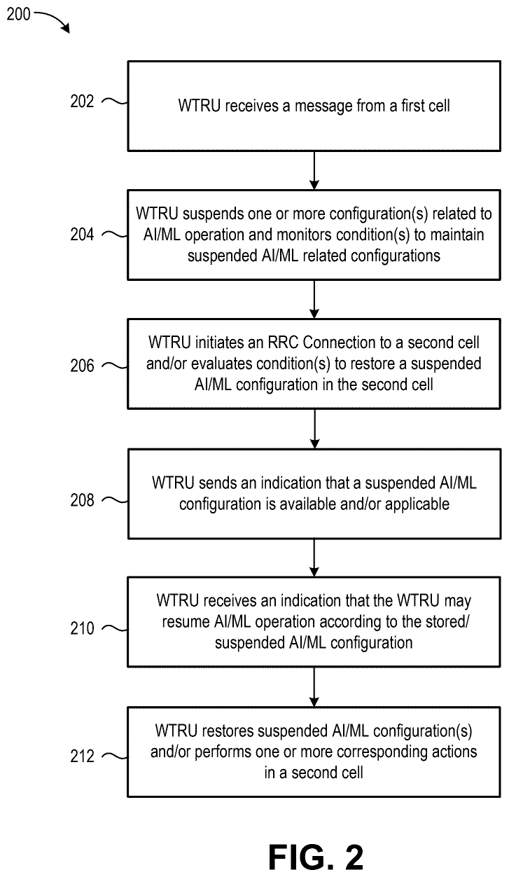

Referring now to FIG. 2, a flow diagram showing an example method 200 for Artificial Intelligence/Machine Learning (AI/ML) configuration and operation management during a Radio Resource Control (RRC) state transition (e.g., change) is illustratively depicted.

A wireless transmit/receive unit (WTRU) may provide maintenance and continued operation of one or more AI/ML configurations upon release to a radio resource control (RRC) IDLE state and/or an RRC INACTIVE state, and/or a subsequent return to an RRC Connected state. The WTRU may maintain one or more or more configurations related to AI/ML operation upon release from the RRC Connected state. While in the RRC IDLE state and/or the RRC INACTIVE state, the WTRU may monitor one or more conditions to maintain one or more suspended AI/ML related configurations. Upon resumption and/or re-establishment of the RRC connection, the WTRU may evaluate one or more conditions to restore a suspended AI/ML configuration and may indicate that a suspended AI/ML configuration is available and/or applicable. The WTRU may restore the suspended AI/ML configuration based on, for example, a network acknowledgment and may perform one or more corresponding AI/ML actions (e.g., performance monitoring, inference, and/or data collection).

A WTRU may be utilized to perform a plurality of actions and/or steps. At 202, a WTRU may receive a message (e.g., a RRC Release with suspend message) from a first cell. The message may include an indication to maintain, store, and/or suspend one or more configurations related to AI/ML operation (e.g., while in RRC INACTIVE). The message may indicate conditions to maintain one or more suspended AI/ML configurations (e.g., while in RRC INACTIVE). The message may indicate conditions to restore one or more suspended AI/ML configurations upon transition (e.g., back) to RRC Connected.

At 204, a WTRU may suspend one or more configurations related to AI/ML operation (e.g., upon transition to an RRC INACTIVE) and may monitor one or more conditions to maintain the suspended AI/ML related configurations (e.g., while in the RRC INACTIVE). Conditions to maintain suspended AI/ML configurations may include, for example, time-based expiry, measurement thresholds, buffer status, WTRU processing capability, and/or an RRC state. If one or more conditions are not satisfied, the WTRU may release the suspended AI/ML configurations, with or without providing an indication to the network.

At 206, the WTRU may initiate an RRC connection to a second cell and may evaluate one or more conditions to restore a suspended AI/ML configuration in the second cell. Conditions to restore a suspended AI/ML configuration may include a reference signal received power (RSRP) thresholds, network (NW)-side conditions, and/or determining whether the first cell and the second cell are the same cell or different cells.

At 208, the WTRU may indicate, for example within an RRC Resume Request message, that a suspended AI/ML configuration is available and/or applicable (e.g., based on satisfaction of the conditions to restore a suspended AI/ML configuration). The indication may also be transmitted via a random access channel (RACH) and/or a WTRU capability message.

At 210, the WTRU may receive an indication (e.g., within an RRC Resume Complete message) that the WTRU may resume AI/ML operation according to the stored and/or suspended AI/ML configuration. The WTRU may receive an updated configuration (e.g., a delta configuration) to apply.

At 212, the WTRU may restore one or more suspended AI/ML configurations and may perform one or more corresponding actions in the second cell. Examples of corresponding actions may include performance monitoring, inference, and/or data collection. The first cell and the second cell may be the same cell.

Maintaining an AI/ML configuration while in an RRC IDLE state and/or an RRC INACTIVE state and/or subsequently resuming a stored configuration upon reconnection to the RRC Connected may reduce latency associated with resuming AI/ML operation. This process may also reduce unnecessary signaling overhead caused by re-reporting of applicable functionalities and/or reconfiguring AI/ML-related configurations. Examples described herein may support the maintenance and continued operation of AI/ML related configurations during release to RRC IDLE and/or INACTIVE and/or subsequent resume to RRC Connected.

As used herein, “AI/ML-related operation” may refer to any operation that may be supported and/or aided by artificial intelligence and/or machine learning. Examples of such operations may include model training, inference, performance monitoring, data collection, and/or applicability reporting. “AI/ML-related configurations” may be defined as one or more configurations (e.g., RRC configuration) to support AI/ML operation.

A WTRU may have a configuration and capability to support AI/ML management during RRC state change. A WTRU may be provided with one or more configurations for AI/ML configuration and operation management during an RRC state change. Examples may include configurations to support one or more of AI/ML operation; AI/ML operation and configuration management upon release to an RRC IDLE state and/or an RRC INACTIVE state; AI/ML operation/configuration management while in an RRC IDLE state and/or an RRC INACTIVE state, and/or AI/ML operation/configuration management upon return to an RRC Connected.

AI/ML configuration and operation management during an RRC state change may only be initiated if it is supported by both the WTRU and the network (NW). A WTRU may indicate capability for one or more aspects of AI/ML configuration and operation management during an RRC state change (e.g., prior to the initiation of the procedure and/or the reception of associated configurations). A NW may indicate support (e.g., per-cell) for one or more aspects of AI/ML configuration and operation management during an RRC state change. A WTRU may, for example, only initiate a procedure and/or expect configuration with one or more cells that support the procedure. The WTRU may support the indication of WTRU capability, NW support, and the reception of one or more configurations for AI/ML configuration and operation management during an RRC state change.

In some examples, a capability may be needed for AI/ML configuration and operation management during RRC state change. This capability may be related to all aspects of the AI/ML configuration and operation management during an RRC state change and/or one or more specific aspects. Support for AI/ML configuration and operation management during an RRC state change may be reported by the WTRU and/or indicated by the network (e.g., on a cell-specific basis).

A WTRU may indicate capability and/or support for one or more aspects of AI/ML configuration and operation management during an RRC state change. The WTRU may indicate a single capability to indicate support for all aspects of AI/ML configuration and operation management during an RRC state change. The WTRU may report support for one or more aspects of AI/ML configuration and operation management during RRC state change. For example, the WTRU may indicate support for one or more of AI/ML configuration management during RRC state change to RRC Inactive, and/or during RRC state change to RRC Idle. The WTRU may indicate support for one or more of AI/ML configuration management during RRC state change to RRC connected, while in RRC Inactive, and/or while in RRC Idle. The WTRU may indicate support for one or more of AI/ML operation management during RRC state changes to RRC Inactive, during RRC state change to RRC Idle, during RRC state change to RRC connected, while in RRC Inactive and/or while in RRC Idle.

The WTRU may report the capability of one or more of the above aspects of AI/ML configuration and operation management during RRC state change, for example, via the WTRU capability transfer procedure. The WTRU may indicate its capability and/or support using one or more of the following methods: random access, which may include the use of one or more dedicated resources such as random access preamble partitioning (e.g., a set of reserved preambles or random access occasions); upon RRC connection establishment or resumption, such as via Msg3 or Msg5; upon receiving a request from the network, such as a capability enquiry message; and/or via WTRU assistance information.

In examples, the capability to support, perform, execute, and/or initiate one or more aspects of AI/ML configuration and operation management during an RRC state change may depend on and/or be linked to one or more other configurations. For example, the network may assume that a WTRU is capable of one or more aspects of AI/ML configuration and operation management during an RRC state change based on factors such as the activation, state, and/or configuration of an AI/ML model and/or functionality. Similarly, the network may rely on the availability of an AI/ML model and/or functionality to assume capability.

The capability and/or support for the initiation of one or more aspects of AI/ML configuration and operation management during an RRC state change may also depend on one or more characteristics of the WTRU. Such characteristics may include the performance of an AI/ML model and/or functionality, the WTRU's speed, the remaining power of the WTRU, the WTRU's processing capability, and/or the WTRU's location (e.g. within a certain set of cells), using one of a set of specific beams, and/or based on GPS location). The capability may also depend on the type of service in use, such as one or more specific network slices or quality of service class indicators (QCIs).

If a WTRU is configured for AI/ML configuration and operation management during an RRC state change but an associated configuration is not present, active, and/or the WTRU characteristics are not suitable, it may be assumed that the procedure may be temporarily disabled (e.g., the WTRU may not initiate the procedure) or inactive. The WTRU may indicate (e.g., subject to configuration) to the network, for example via medium access control (MAC) control element (CE), uplink control information (UCI), and/or RRC signaling, that AI/ML configuration and operation management during an RRC state change is temporarily inactive. In some examples, the WTRU may also report the reason for why the procedure is inactive (e.g., a joint configuration is disabled or the WTRU's characteristics are not suitable).

The network may indicate support for AI/ML configuration and operation management during an RRC state change. Such support may be indicated on a per-cell basis, per public land mobile network (PLMN), per frequency, per tracking area (TA), and/or per radio access network (RAN) notification area (RNA). The indication may be provided, for example, as a flag or bit in system information that identifies support for AI/ML configuration and operation management during an RRC state change. In some examples, the network may indicate support for specific aspects of the procedure, such as support for AI/ML configuration management but not AI/ML operation management. Additionally, and/or alternatively, the network may indicate support via system information and/or RRC configuration by providing a list of one or more cells that support AI/ML configuration and operation management during an RRC state change.

In examples, the WTRU may only initiate AI/ML configuration and operation management during an RRC state change, or perform one or more aspects of AI/ML configuration & operation management during RRC state change subject to the network supporting the procedure. For example, a WTRU may only resume AI/ML operation upon return to an RRC Connected state if the cell has indicated support for AI/ML configuration and operation management during an RRC state change.

Artificial Intelligence/Machine Learning (AI/ML)-related configuration and operation management upon release from RRC Connected may include AI/ML-related configuration and operation management during the RRC state change and within RRC IDLE and INACTIVE states. The AI/ML-related configuration and operation management may include providing indications on how to manage AI/ML-related configurations and operations, such as upon release from the RRC Connected state. Management may also involve the conditional, time-based, or network-controlled maintenance of AI/ML-related configurations while the WTRU operates in RRC IDLE or INACTIVE states. The release and/or suspension of AI/ML-related configurations and/or operations may occur, for example, upon expiry of certain conditions and/or when requested by the network.

Upon returning to the RRC Connected state, AI/ML-related configuration and operation management may focus on the management, availability, and resumption of configurations and operations. This may involve the conditional AI/ML-related configurations upon return to RRC Connected, including, conditional resumption of AI/ML-related configurations and/or operation. An indication of the availability of AI/ML-related configurations may be provided, and AI/ML-related configurations may be modified. Management may include restoring AI/ML configurations and/or resuming AI/ML-related operations.

The WTRU may receive one or more configurations to support AI/ML operations. Configurations may support a variety of AI/ML operations, including model training, inference, performance monitoring, data collection, and/or applicability reporting.

The WTRU may receive configurations for AI/ML model training. Such configurations may include criteria for updating a model, criteria for determining when a model is trained, criteria for downloading a new model, criteria for re-training a model, and/or configurations to train a model, such as duration of training and number of iterations.

The WTRU may also receive configurations to support AI/ML inference. Configurations for inference may include one or more models on which to perform inference, characteristics of the input information needed for the model, and/or network-side conditions and associated identifiers for which the model has been trained.

Configurations for AI/ML performance monitoring may be provided to the WTRU. These configurations may include when to perform performance monitoring, such as periodicity and duration, criteria for performance monitoring, such as thresholds, and/or criteria for reporting performance monitoring results, such as when performance has dropped below a threshold.

The WTRU may receive configurations to support AI/ML data collection. These configurations may include measurement configurations, associated identifiers, NW-side conditions (e.g., conditions associated with the NW, such as WTRU speed, and/or a number of antennas), limits on the amount of data to collect, types of data and/or events to collect, triggers to report collected data, and/or formats for reporting collected data.

The WTRU may further receive configurations for AI/ML applicability reporting. Such configurations may include whether the WTRU should proactively or reactively report applicability, whether the WTRU may report non-applicability, whether the WTRU may transmit updates regarding applicability during an RRC Connected state, and/or triggering conditions to report applicability, such as when a functionality becomes non-applicable.

The WTRU may receive configurations to support the management of AI/ML-related configurations and/or operations during a transition from an RRC Connected state to other RRC states, such as RRC IDLE or RRC INACTIVE. Configurations may support managing AI/ML operations and configurations upon release from the RRC Connected state and/or while in RRC IDLE or RRC INACTIVE states.

The WTRU may receive configurations for AI/ML configuration and/or operation management upon release from an RRC Connected state. These configurations may include whether the WTRU may maintain or perform AI/ML operations while in RRC IDLE and/or RRC INACTIVE states and/or whether the WTRU may maintain AI/ML-related configurations while in RRC IDLE and/or RRC INACTIVE states.

Configurations may also support AI/ML configuration and operation management while in RRC IDLE and/or RRC INACTIVE states. These configurations may include whether the WTRU may autonomously release AI/ML-related configurations, whether the WTRU may autonomously suspend AI/ML operations, conditions, such as thresholds or criteria, to support event-based AI/ML operation and/or configuration management, and/or whether the WTRU should monitor for and receive NW control information related to AI/ML operations while in RRC IDLE and/or RRC INACTIVE states.

The WTRU may receive configurations to support the management of AI/ML-related configurations and/or operations upon returning to an RRC Connected state. Configurations may support AI/ML configuration and operation management upon completion of RRC setup, resume, and/or re-establishment procedures, and/or the resumption of AI/ML operations.

Configurations for AI/ML configuration and operation management upon returning to an RRC Connected state may include whether the WTRU may indicate the availability of a stored configuration available upon RRC connection, whether the WTRU may indicate whether it has a stored configuration applicable upon RRC connection, whether the WTRU may maintain AI/ML configurations upon RRC connection, and/or whether the WTRU may maintain AI/ML operations upon RRC connection.

The WTRU may receive configurations for resumption of AI/ML operations. These configurations may include whether the WTRU may update the AI/ML configuration upon RRC connection, whether the WTRU may continue AI/ML configurations in a new cell, and/or whether the WTRU may continue AI/ML operations in the new cell.

Methods to (re) acquire, adapt, or release configurations for AI/ML configuration and operation management during a radio resource control (RRC) state change may be necessary to ensure that a wireless transmit/receive unit (WTRU) may continue to maintain related AI/ML configurations and/or AI/ML operation.

The WTRU may be provided with configurations for AI/ML configuration and operation management during an RRC state change upon establishment or resumption of an RRC connection. These configurations may be provided within an RRC Setup or Resume message or during handover to another cell, such as within a handover command or an RRC reconfiguration message with a reconfiguration with synchronization. Additionally, configurations for AI/ML configuration and operation management during an RRC state change may be provided at any time during an active RRC connection, such as through an RRC reconfiguration message without synchronization. Configurations may also be indicated, configured, or provided via various signaling methods, including system information blocks (SIBs), non-access stratum (NAS), medium access control (MAC) control elements (CEs), downlink control information (DCI), random access channel (RACH) messaging (e.g., Msg2, Msg4, and/or MsgB), RRC signaling, and/or physical downlink control channel (PDCCH) or physical uplink shared channel (PUSCH) signaling.

In some examples, the WTRU may receive different information or components of a configuration for AI/ML configuration and operation management during an RRC state change via different signaling methods. For instance, the WTRU may receive some dedicated configuration aspects, such as which configurations to maintain or dedicated radio NW temporary identifiers (RNTIs), via RRC signaling, while receiving other configurations or information, such as resources to monitor for a NW indication to manage configurations while outside of the RRC Connected state, via system information. If the WTRU is provided with a dedicated configuration or indication related to AI/ML configuration and operation management during an RRC state change, it may override other common configuration information received via broadcast signaling, combine the dedicated configuration with one or more pieces of common configuration information, or use the most recently received information regardless of the signaling method.

The WTRU may receive one or more alternative configurations using one signaling method (E.g. via system information or dedicated RRC signaling). Using another type of signaling (e.g. via dedicated RRC signaling or MAC CE) the NW may select or indicate which of the one or more alternative configurations to apply.

The WTRU may receive a configuration for AI/ML configuration and operation management during an RRC state change based on a NW decision. For example, this may occur upon release to RRC IDLE or RRC INACTIVE, particularly if the WTRU has indicated that it is capable of AI/ML configuration and operation management during an RRC state change. Additionally, and/or alternatively, the WTRU may request to be configured for AI/ML configuration and operation management during an RRC state change. The WTRU may request configurations for AI/ML configuration and operation management during an RRC state change, update existing configurations, and/or apply different configurations for such management.

The WTRU may release configurations related to AI/ML configuration and operation management during an RRC state change. This release may include all or part of a configuration and may occur under certain circumstances. For example, a release may occur if the current serving cell does not support AI/ML configuration and operation management during an RRC state change or if the WTRU does not have an active, available, configured, or supported AI/ML functionality or model to continue AI/ML operations during the RRC state change.

A WTRU may adapt, such as by changing, one or more aspects of configurations for AI/ML configuration and operation management during an RRC state change based on the WTRU's characteristics. Examples of WTRU characteristics that may prompt adaptation include the WTRU's speed or position, power or battery level, and/or processing capability or load. Upon detecting a change in its characteristics, the WTRU may modify one or more aspects of the current configuration and/or apply a new configuration. Determination of which aspects of the configuration to change may be based on conditions associated with the configuration or the configuration's aspects. For instance, the WTRU may be provided with one or more thresholds, such that if a threshold is exceeded or if a value falls below a threshold, the WTRU may apply an alternative configuration and/or value for the same configuration.

A WTRU may maintain an AI/ML-related configuration and/or continue an AI/ML operation during a radio resource control (RRC) state transition, such as upon release to RRC IDLE or RRC INACTIVE. Which configurations and/or operations the WTRU may maintain can depend on explicit NW indications and/or the satisfaction of one or more conditions. Enabling the WTRU to retain configurations and/or continue AI/ML operations may save signaling overhead and/or may improve AI/ML service continuity. Examples may include supporting the continuation of AI/ML-related configurations and/or operation(s), including the indication to enable continuation upon release from RRC Connected, and the management of AI/ML-related configurations and/or operations while outside of the RRC Connected state.

The WTRU may receive an indication to maintain an AI/ML configuration and/or to continue an AI/ML operation while not in the RRC Connected state. This indication may be received, for instance, upon release from the RRC Connected state, such as within an RRC Release message with a suspend indication upon release to RRC INACTIVE or within an RRC Release message upon release to RRC IDLE. In some cases, the WTRU may be explicitly configured, for example, within the AI/ML configuration itself, to maintain the AI/ML-related configuration and/or to continue AI/ML operations during an RRC state transition.

The WTRU may also receive additional information regarding how to handle AI/ML-related configurations and/or operations upon RRC state transition. This information may include whether the WTRU may maintain all AI/ML-related operations upon release, maintain a specific operation, or maintain operations related to a specific use case. The WTRU may be provided with conditions to maintain AI/ML operations, such as performance monitoring criteria. Similarly, the WTRU may receive information about whether it may maintain all AI/ML-related configurations upon release, maintain specific configurations, or maintain configurations related to a specific use case. Conditions to maintain configurations may include criteria such as time durations. The WTRU may also be provided with resources to monitor for additional NW control.

In some cases, the WTRU may only continue AI/ML-related operations and/or configurations within a specific state. For example, the WTRU may maintain AI/ML-related configurations and operations while in the RRC INACTIVE state but may not continue AI/ML operations in the RRC IDLE state. Additionally, and/or alternatively, the WTRU may terminate AI/ML operations and release all AI/ML-related configurations upon release to RRC IDLE. The actions performed by the WTRU upon release to RRC IDLE, such as receiving the RRC Release message, may differ from those performed upon release to RRC INACTIVE. These differences may be reflected in the content of each message.

The WTRU may receive such indications through methods other than an RRC Release message. For instance, the information may be provided within system information, via random access channel (RACH) signaling, non-access stratum (NAS), other forms of RRC signaling, and/or medium access control (MAC) control elements (CE).

The WTRU may perform an action other than terminating AI/ML operations and/or releasing AI/ML-related configurations upon release from the RRC Connected state. The action taken by the WTRU may depend on indications or configurations provided by the NW and/or on the satisfaction of one or more conditions. The WTRU may perform one or more actions related to AI/ML operations during an RRC state transition and/or while in a state other than RRC Connected. Examples of AI/ML-related operations include model training, inference, performance monitoring, data collection, and/or applicability reporting.

Upon release from the RRC Connected state, WTRU actions related to AI/ML operations may include continuing all currently configured AI/ML operations, continuing a subset of operations, continuing a specific operation, continuing operations associated with a specific configuration or configurations, or continuing operations associated with a specific use case. The actions performed by the WTRU may depend on configurations provided to the WTRU, whether the WTRU maintains a valid AI/ML-related configuration, and/or whether conditions to continue AI/ML operations are fulfilled. Conditions may include the WTRU remaining camped on the cell from which it was released, or the WTRU remaining camped on a cell that supports AI/ML operations or specific AI/ML operations.

If one or more conditions to maintain AI/ML operations are not satisfied, the WTRU may terminate one or more AI/ML-related operations. For example, if the NW indicates that the WTRU may maintain AI/ML configurations related to data collection for a positioning use case, the WTRU may continue operations as long as it remains camped on the current cell or a cell with similar NW-side conditions. The WTRU may perform data collection until it reselects a cell with different NW-side conditions, at which point it may terminate data collection.

A WTRU may perform one or more actions on an artificial intelligence and/or machine learning (AI/ML) configuration during a radio resource control (RRC) state transition, such as upon release to RRC IDLE or RRC INACTIVE, and/or while operating in a state other than RRC Connected. Actions performed by the WTRU may include maintaining and/or releasing all AI/ML-related configurations, maintaining and/or releasing specific AI/ML-related configurations, and/or maintaining and/or releasing AI/ML-related configurations associated with a specific use case. The actions performed by the WTRU may depend on whether the WTRU is configured to maintain one or more AI/ML-related configurations upon release from the RRC Connected state. Additionally, and/or alternatively, the handling of configurations may depend on whether the WTRU must maintain them to continue AI/ML operations. For example, if the WTRU is configured to continue one or more AI/ML operations upon release from RRC Connected, it may maintain the configurations necessary for these operations while releasing others.

The WTRU may receive updated configurations during the RRC state transition, such as within a release message. These configurations may be applied or stored by the WTRU, including while the WTRU operates in RRC IDLE or RRC INACTIVE.

While in RRC IDLE or RRC INACTIVE, a WTRU may perform actions on AI/ML-related configurations and/or operations either automatically upon release from RRC Connected or based on explicit NW indications and/or satisfaction of one or more conditions. The continuation of AI/ML operations and/or the maintenance of AI/ML-related configurations may depend on such conditions. In some cases, the same conditions may apply to both AI/ML-related configurations and operations, while in other cases, the conditions may differ. Conditions may include measurement thresholds, such as reference signal received power (RSRP), reference signal received quality (RSRQ), or signal-to-interference-plus-noise ratio (SINR) values of the current or neighboring cell; performance monitoring criteria, such as whether the WTRU's performance exceeds a configured threshold; buffer states, such as whether the buffer used for data collection is full; processing capability, such as whether the WTRU can handle the processing load required for AI/ML operations; power-saving status, such as whether the WTRU is overheating or in a low-power mode; and/or the RRC state, such as whether the WTRU is in RRC IDLE or INACTIVE.

A WTRU may continue inference-related operations and maintain related configurations as long as the performance of the model remains above a threshold, such as when the difference in estimated position remains within a certain distance. If the performance falls below the threshold, the WTRU may terminate inference operations. Similarly, the WTRU may continue data collection while space remains in the buffer. If the buffer is full, the WTRU may terminate data collection and release related configurations. A WTRU may also perform model training while in RRC INACTIVE but may terminate training if processing requirements or power consumption create excessive strain, such as causing overheating. Additionally, and/or alternatively, the WTRU may continue AI/ML operations upon release to RRC INACTIVE but may release related configurations upon further transition to RRC IDLE.

The WTRU may maintain AI/ML-related configurations and/or operations for a specific time period while in RRC IDLE or INACTIVE. The duration for maintaining configurations and/or operations may be provided within the AI/ML configuration itself or upon release from RRC Connected. Upon release, the WTRU may start a timer with a runtime equal to the specified duration. While the timer runs, the WTRU may perform AI/ML operations and maintain AI/ML configurations. Once the timer expires, the WTRU may terminate AI/ML operations and/or release AI/ML-related configurations. In some cases, the duration for maintaining configurations and performing operations may be the same, while in other cases, they may differ, such as when configurations are maintained longer than operations.

In some examples, whether the WTRU continues AI/ML operations and/or maintains AI/ML-related configurations in RRC IDLE or INACTIVE may depend on NW control. The NW may dynamically manage these configurations and operations using indications. For example, the NW may instruct the WTRU to suspend AI/ML operations, release AI/ML configurations, or resume AI/ML operations. The NW may provide such control via paging messages, small data transmissions, or dedicated monitoring occasions for AI/ML control information. The WTRU may be provided with information to support monitoring and receiving control information, including specific monitoring occasions, durations, periodicities, and/or dedicated or group common radio NW temporary identifiers (RNTIs).

The WTRU may release AI/ML-related configurations and/or suspend AI/ML operations while outside the RRC Connected state under certain circumstances. Examples include the absence of a valid configuration, camping on a cell that does not support AI/ML operations, camping on a cell with NW-side conditions that do not support the configuration, receiving a NW indication to release configurations or suspend operations, and/or failing to meet conditions for continuation. Upon satisfying one or more of these circumstances, the WTRU may autonomously suspend AI/ML operations and/or release configurations. Additionally, and/or alternatively, the WTRU may report to the NW that it is suspending one or more AI/ML operation(s) and/or releasing one or more AI/ML related configuration(s). The WTRU may indicate this to the NW, for example, via small data transmission, via a dedicated resume and/or establishment cause, or via RACH (e.g., via the use of dedicated RACH resources, preambles, RNTIs, and/or RACH occasions.

A WTRU may restore AI/ML-related configurations and/or resume or continue AI/ML operations upon returning to RRC Connected state. This may occur, for example, upon completion of RRC setup, resume, and/or re-establishment procedures. Enabling the WTRU to restore and/or continue configurations and operations may save signaling overhead and improve AI/ML service continuity. The management of AI/ML-related configurations and operations upon return to the RRC Connected state may include evaluating conditions to maintain AI/ML-related configurations and operations, indicating availability, modifying AI/ML-related configurations, and/or restoring AI/ML operations.

Upon returning to the RRC Connected state, the WTRU may perform one or more actions related to AI/ML configurations and/or operations. These actions may depend on indications or configurations provided by the NW and/or the satisfaction of one or more conditions. For example, the WTRU's actions may be based on conditions such as measurements associated with a cell (e.g., reference signal received power (RSRP), reference signal received quality (RSRQ), or signal-to-interference-plus-noise ratio (SINR)) being above a threshold; the cell supporting AI/ML configuration and operation management during RRC state change; and/or the NW-side conditions of the cell being applicable to one or more AI/ML configurations or operations. Additional conditions may include the WTRU resuming or establishing the RRC connection in the same cell it was released from, the WTRU being within a threshold distance from a reference location, or the absolute time measured at the WTRU being within a specified time window (e.g., between T1 and T2). Conditions associated with maintaining AI/ML operations, such as those described in previous sections, may also still need to be satisfied.

In some cases, if the WTRU performs a cell reselection from the cell where the configuration was received to a new cell, it may obtain updated configuration information from the system information of the new cell. For instance, the new cell may indicate the applicability of some, but not all, actions related to AI/ML configurations and operations that were configured by the original cell.

The WTRU may also indicate the availability of AI/ML-related configurations upon returning to the RRC Connected state. For example, upon cell reselection or connection establishment or resumption with a second cell, the WTRU may indicate that it has stored configurations available. The WTRU may provide information about which configurations it has available, which AI/ML operations are supported by existing configurations, and/or which configurations are applicable within the cell where the WTRU is establishing an RRC connection. This indication may be provided during connection establishment, such as within an RRC setup request, resume request, or re-establishment request message. Additionally, and/or alternatively, the WTRU may indicate this information via random access channel (RACH) signaling, using dedicated RACH resources, preambles, radio NW temporary identifiers (RNTIs), or RACH occasions.

In some cases, the WTRU may report this information as part of applicability reporting. The WTRU may indicate that one or more stored configurations are applicable, and the NW may respond, for example, upon connection completion, by indicating that the WTRU may apply one or more applicable configurations upon resume or connection establishment to the new cell.

A WTRU may continue AI/ML-related configurations and/or resume or continue AI/ML operations upon returning to the RRC Connected state. This may occur, for example, upon completion of RRC setup, resume, or re-establishment procedures. Which AI/ML-related configurations and/or operations the WTRU may continue can depend on indications from the NW. The WTRU may resume or continue configurations directly or with modifications based on NW indications or configurations.

In some cases, the NW may provide explicit indications on how to manage AI/ML-related configurations and/or operations upon the WTRU's return to the RRC Connected state. The indications may include maintaining AI/ML-related configurations, modifying one or more configurations, releasing specific configurations, continuing AI/ML operations, terminating AI/ML operations, and/or restoring AI/ML operations. Upon connecting to a new cell (e.g., upon completion of the RRC connection establishment, setup, re-establishment, resume, and/or reconfiguration procedures, the WTRU may perform one or more of the actions indicated by the NW.

The WTRU may adapt or modify one or more configurations related to AI/ML operations (e.g., upon returning to the RRC Connected state). Modifications may apply to the entire configuration or to specific aspects (e.g., parameters and/or values contained within the configuration. The WTRU may apply the revised configuration upon completion of the connection to the new cell and may confirm that the configuration has been applied via, for example, the RRC Reconfiguration Complete, Re-establishment Complete, Resume Complete, and/or Setup Complete message. If the updated configuration only applies to part of the configuration, the WTRU may combine the un-altered configurations with the updated parameters to obtain the full configuration.

The WTRU may restore and/or continue AI/ML related operation and/or configuration upon return to RRC connected. The WTRU may restore all AI/ML related configurations and/or operations, or the WTRU may only restore those configurations and/or operations which satisfy configured conditions and/or have been explicitly indicated by the NW. If the WTRU has previously released configurations but desires to continue AI/ML operations in the new cell, the WTRU may request additional configurations and/or may perform applicability reporting (e.g., to obtain the necessary configurations to perform AI/ML operations).

1. A wireless transmit/receive unit (WTRU) comprising:
a processor configured to:
receive a configuration message associated with a first connectivity state of the WTRU and a second connectivity state of the WTRU, wherein the configuration message comprises an indication to suspend an artificial intelligence/machine learning (AI/ML) configuration related to an AI/ML operation, one or more conditions to maintain a suspended AI/ML configuration, and one or more conditions to restore the suspended AI/ML configuration upon transition from the second connectivity state to the first connectivity state;
suspend the AI/ML configuration when in the second connectivity state;
determine to maintain the suspended AI/ML configuration when in the second connectivity state based on one or more conditions;
determine that the suspended AI/ML configuration can be restored upon transition back to the first connectivity state based on the one or more conditions to restore the suspended AI/ML configuration;
send an indication to a network that indicates that the suspended AI/ML configuration can be restored; and
receive an indication to resume the AI/ML operation according to the restored AI/ML configuration.

2. The WTRU of claim 1, wherein the one or more conditions to maintain the suspended AI/ML configuration comprises an expiration of a timer, a comparison of a measurement to a threshold, a status of a buffer of the WTRU, or a Radio Resource Control (RRC) state of the WTRU.

3. The WTRU of claim 1, wherein the processor is configured to release the suspended AI/ML configuration if the one or more conditions are not met.

4. The WTRU of claim 1, wherein the one or more conditions to restore the suspended AI/ML configuration comprise a measurement being above a threshold, a condition associated with the network, or that the WTRU transitions back to the first connectivity state in the same cell as sent the configuration message to the WTRU.

5. The WTRU of claim 1, wherein the processor is configured to send the indication that indicates that the suspended AI/ML configuration has been restored via a Random Access Channel (RACH) transmission or a WTRU capability message.

6. The WTRU of claim 1, wherein the processor is configured to:
receive an updated configuration; and
apply the updated configuration to the restored AI/ML configuration.

7. The WTRU of claim 1, wherein the processor is configured to:
restore the suspended AI/ML configuration based on the indication that the WTRU should resume the AI/ML operation according to the restored AI/ML configuration.

8. The WTRU of claim 1, wherein the processor is configured to:
perform one or more actions associated with the AI/ML operation after the suspended AI/ML configuration is restored, wherein the one or more actions comprise at least one of performance monitoring, inference, or data collection.

9. The WTRU of claim 1, wherein the configuration message is received via a first cell, the indication that indicates that the suspended AI/ML configuration has been restored is sent via a second cell, and the indication that the WTRU should resume the AI/ML operation according to the restored AI/ML configuration is received via the second cell, wherein the second cell is different from the first cell.

10. The WTRU of claim 1, wherein the first connectivity state of the WTRU is a Radio Resource Control (RRC) Connected state, and the second connectivity state of the WTRU is an RRC INACTIVE state.

11. A method implemented by a wireless transmit/receive unit (WTRU), the method comprising:
receiving a configuration message associated with a first connectivity state of the WTRU and a second connectivity state of the WTRU, wherein the configuration message comprises an indication to suspend an artificial intelligence/machine learning (AI/ML) configuration related to an AI/ML operation, one or more conditions to maintain a suspended AI/ML configuration, and one or more conditions to restore the suspended AI/ML configuration upon transition from the second connectivity state to the first connectivity state;
suspending the AI/ML configuration when in the second connectivity state;
determining to maintain the suspended AI/ML configuration when in the second connectivity state based on one or more conditions;
determining that the suspended AI/ML configuration can be restored upon transition back to the first connectivity state based on the one or more conditions to restore the suspended AI/ML configuration;
sending an indication to a network that indicates that the suspended AI/ML configuration can be restored; and
receiving an indication to resume the AI/ML operation according to the restored AI/ML configuration.

12. The method of claim 11, wherein the one or more conditions to maintain the suspended AI/ML configuration comprise an expiration of a timer, a comparison of a measurement to a threshold, a status of a buffer of the WTRU, or a Radio Resource Control (RRC) state of the WTRU.

13. The method of claim 11, further comprising releasing the suspended AI/ML configuration if the one or more conditions are not met.

14. The method of claim 11, wherein the one or more conditions to restore the suspended AI/ML configuration comprise a measurement being above a threshold, a condition associated with the network, or the WTRU transitioning back to the first connectivity state in the same cell as sent the configuration message to the WTRU.

15. The method of claim 11, further comprising sending the indication that indicates that the suspended AI/ML configuration has been restored via a Random Access Channel (RACH) transmission or a WTRU capability message.

16. The method of claim 11, further comprising:
receiving an updated configuration; and
applying the updated configuration to the restored AI/ML configuration.

17. The method of claim 11, further comprising restoring the suspended AI/ML configuration based on the indication that the WTRU should resume the AI/ML operation according to the restored AI/ML configuration.

18. The method of claim 11, further comprising performing one or more actions associated with the AI/ML operation after the suspended AI/ML configuration is restored, wherein the one or more actions comprise at least one of performance monitoring, inference, or data collection.

19. The method of claim 11, wherein the configuration message is received via a first cell, the indication that indicates that the suspended AI/ML configuration has been restored is sent via a second cell, and the indication that the WTRU should resume the AI/ML operation according to the restored AI/ML configuration is received via the second cell, wherein the second cell is different from the first cell.

20. The method of claim 11, wherein the first connectivity state of the WTRU is an Radio Resource Control (RRC) CONNECTED state, and the second connectivity state of the WTRU is an RRC INACTIVE state.
